(19) United States
(12) Patent Application Publication
(10) Pub. No.: US 2026/0163295 A1
(43) Pub. Date: Jun. 11, 2026

(54) CONNECTOR AND WIRE HARNESS

(71) Applicant: YAZAKI CORPORATION, Tokyo (JP)

(72) Inventor: Hiroki Kitagawa, Makinohara-shi (JP)

(21) Appl. No.: 19/412,837

(22) Filed: Dec. 8, 2025

(30) Foreign Application Priority Data
Dec. 11, 2024 (JP) 2024-216140

(51) Int. Cl. H01R 13/52; B60R 16/02; H01R 13/502

(52) U.S. Cl. CPC H01R 13/5202; B60R 16/0215; H01R 13/502; H01R 13/5213; H01R 13/5216; H01R 2201/26

(57) ABSTRACT

A connector includes a connector housing, a first cover, a second cover, and a seal portion. The connector housing has a fitting portion that is capable of being fitted to a mating connector in a first direction. The first cover has a first opening and covers the connector housing from a side opposite to the fitting portion in the first direction. The second cover has a second opening and covers the first opening. The seal portion is an elastic body extending in the first direction. The connector housing includes a base portion having either a hole or a recess. The seal portion is attached to the base portion. The seal portion protrudes to outside of the second cover through the first opening and the second opening in the first direction. The first cover has a wall portion that covers a part of the seal portion in a second direction.

### BACKGROUND OF THE INVENTION

### Field of the Invention

The present disclosure relates to a connector and a wire harness.

Priority is claimed on Japanese Patent Application No. 2024-216140 filed in Japan on Dec. 11, 2024, the content of which is incorporated herein by reference.

### Description of Related Art

It is known to perform routing by bending a terminal-attached electric wire.

Patent Document 1(Japanese Unexamined Patent Application, First Publication No. 2019-110083) discloses “a waterproof structure of a connector, including: a housing that holds a terminal and has an opening; a cover; and a packing”. The cover closes the opening. The packing is mounted on the cover and seals a space between the housing and the cover at the opening. The cover has a through hole and a protrusion protruding from an outer surface of the cover. The packing includes a main body sandwiched between the housing and the cover, and a locked portion connected to the main body. The locked portion protrudes from the through hole toward an external space of the cover in a protruding direction of the protrusion. The locked portion is locked by the protrusion at least in a direction orthogonal to the protruding direction of the protrusion.

### PRIOR ART DOCUMENT

### Patent document

Patent Document 1: Japanese Unexamined Patent Application, First Publication No. 2019-110083

### SUMMARY OF THE INVENTION

In the invention according to Patent Document 1, the movement of the locked portion toward the tip of the protrusion is suppressed, and the locked portion is less likely to come off from the protrusion. Thus, the invention according to Patent Document 1 has the effect of suppressing unintentional detachment of the packing.

Depending on the connector, it can be further required to suppress the unintentional detachment of the packing.

One embodiment is to provide a connector and a wire harness.

A connector according to one embodiment includes a connector housing, a first cover, a second cover, and a seal portion. The connector housing has a fitting portion that is able to be fitted to a mating connector in a first direction. The first cover has a first opening and covers the connector housing from a side opposite to the fitting portion in the first direction. The second cover has a second opening and covers the first opening. The seal portion is an elastic body extending in the first direction and including a first locking portion, a second locking portion, and a flange portion. The connector housing includes a base portion having either a hole or a recess in the first direction. The first locking portion is attached to the base portion at either the hole or the recess. The second locking portion protrudes to outside of the second cover through the first opening and the second opening in the first direction. The flange portion has a first surface in contact with the second cover. The first cover has a wall portion that covers the second locking portion in a second direction. The wall portion is arranged in the second direction with respect to the second cover. The second direction intersects with the first direction.

According to one embodiment, it is easy to suppress unintentional detachment of the packing.

### BRIEF DESCRIPTION OF THE DRAWINGS

FIG. 1 is a perspective view I illustrating a connector of a first embodiment.

FIG. 2 is a perspective view II illustrating the connector of the first embodiment.

FIG. 3 is a plan view illustrating the connector of the first embodiment.

FIG. 4 is a cross-sectional view taken along line F4-F4 of the connector illustrated in FIG. 3.

FIG. 5 is a partially enlarged view in which a part of the connector illustrated in FIG. 4 is enlarged.

### DETAILED DESCRIPTION OF THE INVENTION

Hereinafter, each embodiment according to the present disclosure will be described with reference to the drawings. Note that the drawings and specific constitutions used in each embodiment should not be used to interpret the disclosure. In all the drawings, the same or corresponding constitutions are denoted by the same reference numbers, and the common description will be omitted.

In the present disclosure, a +X direction, a −X direction, a +Y direction, a −Y direction, a +Z direction, and a −Z direction are defined as follows. The −Z direction is a direction in which a mating connector is fitted. The +Z direction is a direction opposite to the −Z direction. Hereinafter, in a case where the −Z direction and the +Z direction are not distinguished, the directions are simply referred to as “Z direction”. The X direction is a direction crossing (for example, orthogonal to) the Z direction. The −X direction is one direction of the X direction. The +X direction is a direction opposite to the −X direction. Hereinafter, the −X direction and the +X direction are simply referred to as “X direction” when they are not distinguished from each other. The −Y direction and the +Y direction are directions intersecting (for example, orthogonal to) the Z direction and the X direction. Hereinafter, the −Y direction and the +Y direction are simply referred to as “Y direction” when they are not distinguished from each other. The Z direction is an example of a “first direction”. The X direction is an example of a “second direction”. The Y direction is an example of a “third direction”.

Note that the above expression is an expression for convenience of description and does not limit an insertion and removal direction of a connector 200.

### First Embodiment

Hereinafter, a wire harness 300 of one embodiment will be described with reference to the drawings.

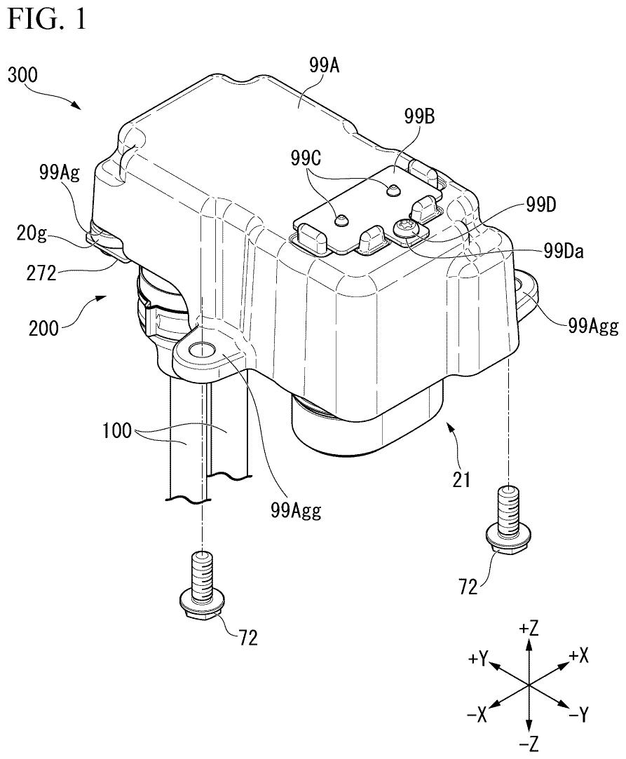

FIG. 1 is a perspective view illustrating the wire harness 300 of a first embodiment. The connector 200 is a connection component for electrically connecting an electric wire 101 and a mating fitting portion to be described later. The connector 200 is, for example, a connector for use in a vehicle such as an electric vehicle (EV), a hybrid electric vehicle (HEV), or a plug-in hybrid electric vehicle (PHEV).

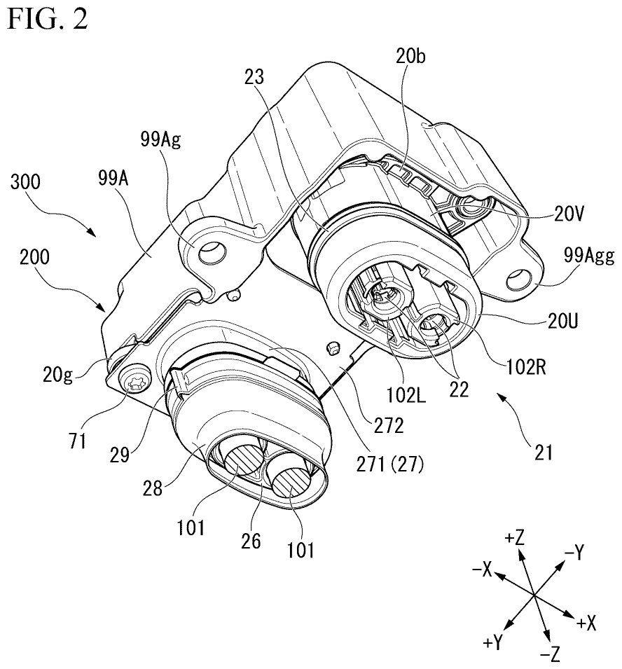

As illustrated in FIGS. 1 to 3, the wire harness 300 includes the connector 200 and at least one or more terminal-attached electric wires 100. The wire harness 300 is a connector-attached electric wire including the connector 200 assembled to a terminal of the terminal-attached electric wire 100. At least one or more terminal-attached electric wires 100 are inserted into the connector 200 according to the number of poles included in the connector 200. For example, in the present embodiment, the wire harness 300 includes two terminal-attached electric wires 100 and a two-pole connector 200.

First, the terminal-attached electric wire 100 will be described.

### (Constitution of Terminal-Attached Electric Wire)

The terminal-attached electric wire 100 includes an electric wire 101 and a terminal portion 102. The electric wire 101 includes a core wire 101A that is a conductor and a covering portion 101B that covers the core wire. At the end of the electric wire 101, the covering portion 101B is partially peeled off, and the core wire 101A is exposed.

### (Constitution of Terminal Portion)

The terminal portion 102 is formed of a conductive material such as metal. For example, the terminal portion 102 is formed into a predetermined shape by performing bending, press molding such as cutting, or the like on a metal plate as a base material.

The terminal portion 102 includes a terminal connection portion 102A and a wire connection portion 102B. The terminal connection portion 102A can be fitted to a terminal connection portion 511 included in a mating terminal fitting 510. The wire connection portion 102B is electrically connected to the core wire 101A exposed at the end of the electric wire 101.

The terminal connection portion 102A is electrically connected to the terminal fitting 510 by fitting the terminal connection portion 511 to the terminal connection portion 102A along the first direction (Z direction). The terminal connection portion 102A has a spring characteristic and can maintain a connection state between contacts by applying a spring force between itself and the terminal connection portion 511. The spring force acts in a direction intersecting the first direction. Examples of the terminal connection portion 102A on which the spring force acts include the following. For example, in a case where the terminal connection portion 102A has a tubular female terminal shape, the terminal connection portion 102A may have a spring characteristic by separately assembling a contact spring in the tube. In addition, in a case where the tubular portion of the terminal connection portion 102A is curved, the terminal connection portion 102A may have a spring characteristic by providing a slit in the tubular portion. For example, in the present embodiment, the terminal connection portion 102A has a tubular female terminal shape, and a contact spring is separately assembled in the tube. In accordance with the shape of the terminal connection portion 102A, the terminal connection portion 511 is formed in a shaft-shaped male terminal shape to be fitted inside the terminal connection portion 102A. Note that, in the terminal connection portion 102A, the axis of the terminal connection portion 102A is along the first direction.

The wire connection portion 102B is electrically connected to the core wire 101A exposed at the end of the electric wire 101. For example, the exposed core wire 101A of the wire connection portion 102B is crimped to the wire connection portion 102B, or the exposed core wire 101A is welded to the wire connection portion 102B, whereby the terminal portion 102 is assembled to the terminal of the electric wire 101.

### (Constitution of Connector)

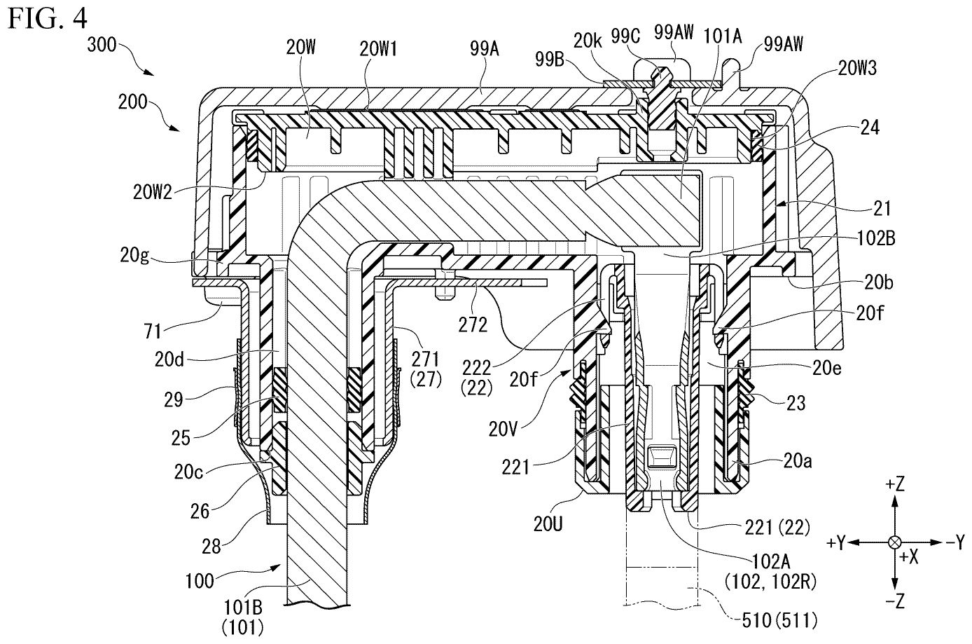

The connector 200 is fitted to the mating fitting portion (not illustrated) by inserting a fitting portion 20a into the mating fitting portion in the −Z direction. By fitting, the connector 200 is electrically connected to the terminal fitting 510 (see FIG. 4). The terminal fitting 510 is provided on a terminal block included in a counterpart apparatus or a mating connector. The wire harness 300 is electrically connected to the counterpart apparatus by electrical connection between the connector 200 and the terminal fitting 510. As illustrated in FIGS. 1 to 4, the connector 200 includes a connector housing 21, at least one or more terminal holding members 22, a seal member 23, a seal member 24, a seal member 25, a wire holding tool 26, a shield shell 27, a braided member 28, a seal ring 29, a first cover 99A, a second cover 99B, a seal member 99C, and a fixing member 99D.

In the connector 200 in the present embodiment, the connector housing 21, the seal member 99C, the first cover 99A, and the second cover 99B are arranged in this order toward the outside of the connector housing 21. At this time, the seal member 99C passes through part of the first cover 99A and protrudes toward the outside of the connector housing 21. The seal member 99C passes through part of the second cover 99B and protrudes toward the outside of the connector housing 21. The seal member 99C in the present embodiment is a rod-shaped seal member extending in the first direction (for example, in the Z direction). Note that the main portion of the seal member 99C may be formed in an annular shape, and the main portion may be provided with a rod-shaped seal portion extending in the first direction. In this case, the rod-shaped seal portion may not be provided with respect to the main portion. That is, a protruding seal portion may be provided in the main portion instead of the rod-shaped seal portion. It is sufficient that the seal member 99C passes through part of the first cover 99A and part of the second cover 99B and protrudes toward the outside of the connector housing 21. The seal member 99C is formed of an elastic member such as synthetic rubber.

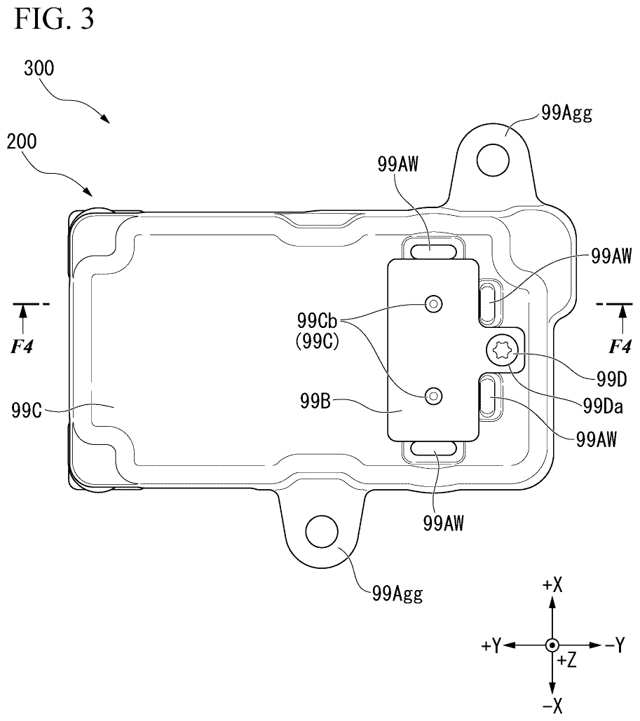

The connector 200 includes plural sets of combinations of the electric wire 101 and the terminal portion 102. For example, the connector 200 according to the present embodiment includes two sets of combinations by including two terminal holding members 22 (see FIG. 3). In the connector 200, two terminal portions 102 (a terminal portion 102L, a terminal portion 102R) are disposed side by side in the X direction. In addition, in the connector 200, two electric wires 101 are arranged side by side and run in parallel.

Hereinafter, the insertion direction of the fitting portion 20a of the connector 200 with respect to the mating fitting portion is the −Z direction. In addition, the removal direction of the fitting portion 20a of the connector 200 with respect to the mating fitting portion is the +Z direction.

The connector housing 21 has an insulating property and accommodates the electric wire 101 and the terminal portion 102. The connector housing 21 is formed of an insulating material such as synthetic resin. The connector housing 21 includes a front holder 20U, a housing body 20V, and a cover member 20W.

The front holder 20U covers the outer peripheral surface of the fitting portion 20a included in the housing body 20V. The front holder 20U is a member formed in a rectangular tube shape. The front holder 20U and the fitting portion 20a are assembled by mechanical joining such as snap-fitting.

The housing body 20V is a frame body opened in the Z direction. The housing body 20V has a plurality of openings in the Z direction. The housing body 20V in the present embodiment has a first opening and a second opening. The first opening is an opening for drawing out the electric wire 101. The second opening is an opening for partially accommodating the terminal holding member 22. In the present embodiment, a first accommodating portion 20d is exemplified as an example of the first opening, and a second accommodating portion 20e is exemplified as an example of the second opening. The housing body 20V and the cover member 20W are assembled by mechanical joining such as snap-fitting. The housing body 20V includes the fitting portion 20a, a flange portion 20b, a lead-out port 20c, at least one or more first accommodating portions 20d, at least one or more second accommodating portions 20e, a locking portion 20f, and a fixing portion 20g.

The cover member 20W has a plate shape along the X direction and the Y direction. The cover member 20W has a first surface 20W1 and a second surface 20W2. The first surface 20W1 is a surface facing the first cover 99A. The second surface 20W2 is a surface facing the housing body 20V. A stepped surface 20W3 connecting the first surface 20W1 and the second surface 20W2 and having a stepped shape is formed on the side peripheral surface of the cover member 20W. The seal member 24 is assembled to the stepped surface 20W3. The cover member 20W covers the opening included in the housing body 20V.

As described above, in the connector 200, the connector housing 21, the seal member 99C, the first cover 99A, and the second cover 99B are arranged in this order toward the outside of the connector housing 21. At this time, the connector housing 21 includes a base portion 20k having either a hole or a recess in the first direction (for example, in the Z direction). In the connector housing 21 according to the present embodiment, the cover member 20W includes the base portion 20k having either a hole or a recess in the first direction (for example, in the Z direction). The base portion 20k protrudes toward an opening 99Aop to be described later. The tip surface of the base portion 20k in the present embodiment is located on the +Z direction side with respect to the first surface 20W1. A first locking portion 99Ca of the seal member 99C is attached to the base portion 20k. At this time, the base portion 20k may have an inclined surface 20W4. The inclined surface 20W4 is a surface corresponding to the shape of the first locking portion 99Ca. The inclined surface 20W4 is inclined so as to expand toward the first opening 99Aop.

Hereinafter, the constitution of the housing body 20V will be described in detail.

The fitting portion 20a is a tubular member having an axis in an insertion and removal direction with respect to the mating fitting portion. For example, in the present embodiment, the fitting portion 20a is formed in a rectangular tube shape. As described above, the front holder 20U and the fitting portion 20a are assembled by mechanical joining such as snap-fitting.

The flange portion 20b limits a fitting length of the fitting portion 20a with respect to the mating fitting portion when the connector 200 is fitted to the mating fitting portion. The flange portion 20b protrudes from a part of the outer peripheral surface of the fitting portion 20a toward the outside of the connector 200.

For example, the connector 200 is configured such that the fitting portion 20a can be fitted in the insertion direction inside a mating fitting portion that has a hole shape and that has an inner peripheral wall surface. In the connector 200, the fitting portion 20a is inserted into and removed from the mating fitting portion having a hole shape along the hole axis direction of the mating fitting portion. The mating fitting portion is formed such that, for example, a cross section orthogonal to the hole axis direction forms a rectangular shape. Note that the mating fitting portion may be formed in a tubular shape, and the fitting portion 20a may be able to be fitted in a space inside the mating fitting portion.

The lead-out port 20c is an opening portion for drawing out, to the outside of the connector 200, the electric wire 101 routed from the second accommodating portion 20e to the first accommodating portion 20d. In the present embodiment, the first accommodating portion 20d and the lead-out port 20c communicate with each other. Since the first accommodating portion 20d and the lead-out port 20c communicate with each other, the lead-out port 20c in the present embodiment is open in the Z direction. The lead-out port 20c partially accommodates the wire holding tool 26. The routing direction of the electric wire 101 from the inside to the outside of the connector 200 is determined by the direction in which the lead-out port 20c opens. Note that the lead-out port 20c may accommodate the entire wire holding tool 26.

The first accommodating portion 20d accommodates the seal member 25. The first accommodating portion 20d is provided in the housing body 20V. The accommodated seal member 25 is disposed inside the connector 200 with respect to the wire holding tool 26.

The second accommodating portion 20e accommodates the terminal holding member 22. At least one second accommodating portion 20e is provided in the housing body 20V. The accommodated terminal holding member 22 is held inside the fitting portion 20a. At this time, a part of the terminal holding member 22 protrudes from the peripheral edge of the fitting portion 20a. When the terminal holding member 22 is held by the second accommodating portion 20e and the locking portion 20f, the movement of the terminal holding member 22 in the connector 200 is suppressed in the second accommodating portion 20e.

As described above, in the connector housing 21 according to the present embodiment, the terminal portion 102 of the electric wire 101 is accommodated in the second accommodating portion 20e located inside the connector 200, and the electric wire 101 is drawn out from the lead-out port 20c toward the outside of the connector 200 in the direction along the insertion and removal direction of the connector 200.

The locking portion 20f holds the terminal holding member 22 accommodated in the second accommodating portion 20e. For example, in the present embodiment, the locking portion 20f is a fitting claw, and the locked state of the fitting claw is maintained by a locked portion 222 included in the terminal holding member 22. The fitting claw (locking portion 20f) and the locked portion 222 are assembled by snap-fitting.

For example, in the present embodiment, the housing body 20V has the locking portion 20f for each terminal holding member 22. In addition, as illustrated in FIG. 4, since the housing body 20V has a pair of locking portions 20f and a pair of locked portions 222, the terminal holding member 22 is easily held in the second accommodating portion 20e. For example, in the present embodiment, the pair of locking portions 20f are arranged along the Y direction.

The fixing portion 20g is an attachment portion for assembling the shield shell 27. An insertion hole through which a fastening member (for example, a screw or bolt) not illustrated can be inserted is formed in the fixing portion 20g.

The terminal holding member 22 holds the terminal portion 102. The terminal holding member 22 is accommodated in the second accommodating portion 20e. The terminal holding member 22 is formed of an insulating material such as synthetic resin. The terminal holding member 22 can accommodate the terminal portion 102 inward in a state where the terminal connection portion 511 can be inserted and removed. The terminal holding member 22 is held inside the fitting portion 20a. The terminal holding member 22 may be provided for each electric wire 101 or may be provided as one component capable of holding a plurality of terminal portions 102. For example, in the present embodiment, the terminal holding member 22 is provided for each terminal portion 102.

The terminal holding member 22 includes a cylindrical portion 221 that accommodates the terminal connection portion 102A, and the locked portion 222. The locked portion 222 serves to maintain a locked state of the locking portion 20f. The locked portion 222 has a hole that can be fitted to the locking portion 20f.

When inserted into the housing body 20V from the +Z direction toward the −Z direction, the terminal holding member 22 is locked by the locking portion 20f, and the terminal holding member 22 is held in the second accommodating portion 20e.

The seal member 23 fills a gap between the front holder 20U and the housing body 20V and has a waterproof and dustproof function at an assembly place of the connector 200. The seal member 23 is assembled to the outer peripheral surface of the fitting portion 20a. The seal member 23 is formed of an elastic member such as synthetic rubber.

The seal member 24 fills a gap between the inner wall of the housing body 20V and the cover member 20W and has a waterproof and dustproof function at an assembling portion of the connector 200. The seal member 24 is assembled to the stepped surface 20W3 formed on the cover member 20W. The seal member 24 is formed of an elastic member such as synthetic rubber. For example, the seal member 24 is formed in a rectangular annular shape and is clamped between the housing body 20V and the cover member 20W.

The seal member 25 fills a gap between the inner wall of the housing body 20V in the first accommodating portion 20d and the electric wire 101 and has a waterproof and dustproof function in the lead-out port 20c. The seal member 25 is formed of an elastic member such as synthetic rubber. The seal member 25 may be provided for each electric wire 101 or may be provided so as to fill a gap between the inner wall of the housing body 20V in the first accommodating portion 20d and a plurality of electric wires 101. For example, in the present embodiment, the seal member 25 is provided so as to fill a gap between the inner wall of the housing body 20V in the first accommodating portion 20d and two electric wires 101.

The wire holding tool 26 holds the electric wire 101. The wire holding tool 26 is accommodated in the first accommodating portion 20d. The wire holding tool 26 is molded using an insulating material such as synthetic resin. The wire holding tool 26 may be provided for each electric wire 101 or may be provided as one component capable of holding a plurality of electric wires 101. For example, in the present embodiment, the wire holding tool 26 is provided as one component capable of holding two electric wires 101.

The wire holding tool 26 and the housing body 20V are assembled by mechanical joining such as snap-fitting. The wire holding tool 26 is provided with a through hole through which the electric wire 101 can be inserted and which can hold the electric wire 101. When the electric wire 101 is inserted into the wire holding tool 26, the electric wire 101 is held in the first accommodating portion 20d. In the second direction (for example, in the X direction), the wire holding tool 26 holds the one electric wire 101 and the other electric wire 101 apart from each other.

The shield shell 27 suppresses intrusion of noise generated outside the connector 200 into the inside of the connector 200. The shield shell 27 covers a part of the connector housing 21 so that the electric wire 101 and/or the terminal portion 102 incorporated in the connector housing 21 are not easily affected by noise. The shield shell 27 is formed of a conductive material such as metal.

The shield shell 27 includes a cylindrical portion 271 and a flange portion 272 provided at one end of the cylindrical portion 271. The cylindrical portion 271 is opened in the Z direction and covers the housing body 20V at the opening. The cylindrical portion 271 in the present embodiment is located on the first accommodating portion 20d side. At this time, the electric wire 101 is inserted into the cylindrical portion 271. The flange portion 272 covers part of the electric wire 101 routed from the second accommodating portion 20e to the first accommodating portion 20d. The flange portion 272 is a plate-shaped member extending along the X direction and the Y direction. The through hole 272c through which a fastening member 71 (for example, a screw or bolt) can be inserted is formed in the flange portion 272. Note that the cylindrical portion 271 may be located on the first accommodating portion 20d side.

The braided member 28 covers the electric wire 101 inserted through the cylindrical portion 271 while covering the cylindrical portion 271 of the shield shell 27 in a close contact state. The braided member 28 is knitted in a tubular mesh shape and has conductivity.

The seal ring 29 is crimped to clamp the braided member 28 together with the outer peripheral surface of the cylindrical portion 271. The seal ring 29 is an annular member along the outer peripheral surface of the cylindrical portion 271.

Hereinafter, the first cover 99A, the second cover 99B, and the seal member 99C will be described in detail.

### (Constitution of First Cover 99A)

Similarly to the shield shell 27, the first cover 99A suppresses intrusion of noise generated outside the connector 200 into the inside of the connector 200. The first cover 99A has a shape that follows the outer shape of the connector housing 21 so that the electric wire 101 and/or the terminal portion 102 incorporated in the connector housing 21 are not easily affected by noise. The first cover 99A is formed of a conductive material such as metal.

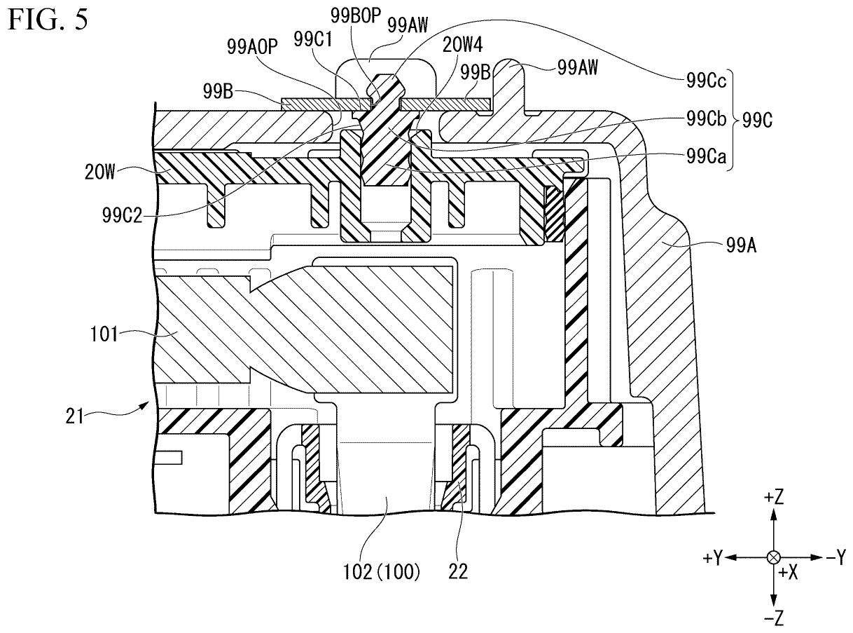

As illustrated in FIG. 5, the first cover 99A has the opening 99Aop. The first cover 99A covers the connector housing 21 from the side opposite to the fitting portion 20a in the first direction (for example, in the Z direction). The first cover 99A in the present embodiment covers the connector housing 21 from the −Z direction side.

The first cover 99A includes at least one wall portion 99AW. The wall portion 99AW covers a second locking portion 99Cb in a direction (for example, in the Y direction and the X direction) intersecting the first direction. For example, when viewed from the direction intersecting the first direction, the second locking portion 99Cb is blocked by the wall portion 99AW.

For example, the first cover 99A may cover the second locking portion 99Cb in the second direction (for example, in the X direction) and the third direction (for example, in the Y direction). For example, the first cover 99A in the present embodiment has four wall portions 99AW. The first cover 99A in the present embodiment has two wall portions 99AW in the second direction. Each of the wall portions 99AW has a side in a short direction that extends along the second direction and covers the second locking portion 99Cb in the second direction. With respect to the wall portion 99AW in the second direction, one wall portion 99AW is arranged with respect to the other wall portion 99AW with the second cover 99B interposed therebetween. The first cover 99A in the present embodiment has two wall portions 99AW in the third direction. Each of the wall portions 99AW has a side in a short direction that extends along the third direction and covers the second locking portion 99Cb in the third direction. With respect to the wall portion 99AW in the third direction, one wall portion 99AW is arranged in the second direction with respect to the other wall portion 99AW.

All the wall portions 99AW are arranged in a direction (for example, in the Y direction and the X direction) intersecting the second cover 99B in the first direction.

The first cover 99A has a fixing portion 99Da. In the fixing portion 99Da, the fixing member 99D is fixed in the first direction. The fixing member 99D fixes the first cover 99A and the second cover 99B in the first direction (for example, in the Z direction). For example, when the fixing member 99D is a screw or a bolt, an insertion hole through which the screw or the bolt can be inserted is formed in the fixing portion 99Da.

In addition, the wall portion 99AW may be located on the rotation locus of the second cover 99B around the axis of the insertion hole formed in the fixing portion 99Da. That is, the wall portion 99AW may be located on the rotation locus of the second cover 99B fixed to the fixing member 99D.

In addition, the first cover 99A is provided with two fixing portions 99Agg. In the fixing portion 99Agg, an insertion hole through which the fastening member 72 (for example, a screw or bolt) can be inserted is formed in the fixing portion 20g.

In addition, the first cover 99A is provided with a fixing portion 99Ag. The fixing portion 99Ag is formed with a screw portion, and in the above-described housing body 20V, the fixing portion 20g for attaching to the fixing portion 99Ag is provided to correspond to the fixing portion 99Ag.

The connector 200 in the present embodiment is fastened to the counterpart apparatus by using two fixing portions 99Agg provided on the first cover 99A. Since the first cover 99A, the shield shell 27, and the braided member 28 are electrically connected to the counterpart apparatus via the fastening member 71, noise directed toward the inside of the connector 200 is suppressed.

### (Constitution of Second Cover 99B)

As illustrated in FIG. 5, the second cover 99B covers the opening 99Aop. The second cover 99B has an insertion hole through which the fixing member 99D can be inserted. The second cover 99B has an opening 99Bop. The second cover 99B in the present embodiment has two openings 99Bop. The second cover 99B is formed of a conductive material such as metal. The second cover 99B is located such that part of the second cover 99B overlaps part of the first cover 99A when viewed from the first direction.

### (Constitution of Seal Member 99C)

The seal member 99C fills a gap between the first cover 99A and the second cover 99B and ensures a waterproof and dustproof function in the opening 99Aop. The second locking portion 99Cb protrudes toward the outside of the second cover 99B through the opening 99Aop and the opening 99Bop, whereby the gap is filled.

The seal member 99C extends in the first direction (for example, in the Z direction). The seal member 99C includes the first locking portion 99Ca, the second locking portion 99Cb, and a flange portion 99Cc. The seal member 99C has a first surface 99C1 and a second surface 99C2. The first surface 99C1 is a surface that extends along the X direction and the Y direction and is in contact with the second cover 99B. The second surface 99C2 is a surface facing either the hole or the recess included in the base portion 20k.

The first locking portion 99Ca is attached to the base portion 20k at either the hole or the recess included in the base portion 20k. At that time, the seal member 99C may have the following surface. The seal member 99C has the second surface 99C2 that has a diameter gradually increasing from the first locking portion 99Ca to the flange portion 99Cc at either the hole or the recess.

The second locking portion 99Cb in the present embodiment protrudes toward the outside of the second cover 99B through the opening 99Aop and the opening 99Bop in the first direction.

### (Constitution of Fixing Member 99D)

As described above, the fixing member 99D fixes the first cover 99A and the second cover 99B in the first direction (for example, in the Z direction). Examples of the fixing member 99D include a screw or a bolt, a nut, or a rivet. The fixing member 99D may cover the second locking portion 99Cb in a direction (for example, in the Y direction and the X direction) intersecting the first direction. For example, when viewed from the direction intersecting the first direction, the second locking portion 99Cb is blocked by the fixing member 99D. For example, a head of the screw or the bolt which is the fixing member 99D may cover the second locking portion 99Cb.

Since the first cover 99A and the second cover 99B are fixed by the fixing member 99D, a gap between the opening 99Aop and the opening 99Bop is more easily filled. Note that a gasket or packing may also be disposed between the first cover 99A and the second cover 99B. In this case, the gasket or the packing is provided in a region where the first cover 99A and the second cover 99B overlap when viewed from the first direction. The waterproof and dustproof function in the opening 99Aop can be improved.

### (Operations and Effects)

In the present embodiment, the connector 200 includes the connector housing 21, the first cover 99A, the second cover 99B, and a seal portion (seal member 99C). The connector housing 21 has the fitting portion 20a that can be fitted to the mating connector in the first direction. The first cover 99A has a first opening (opening 99Aop) and covers the connector housing 21 from the side opposite to the fitting portion 20a in a first direction (for example, in the Z direction). The second cover 99B has a second opening (opening 99Bop) and covers the first opening (opening 99Aop). The seal portion is an elastic body extending in the first direction and including the first locking portion 99Ca, the second locking portion 99Cb, and the flange portion 99Cc. The connector housing 21 includes the base portion 20k having either a hole or a recess in the first direction. The first locking portion 99Ca is attached to the base portion 20k at either the hole or the recess. The second locking portion 99Cb protrudes toward the outside of the second cover 99B through the first opening and the second opening in the first direction. The flange portion 99Cc has the first surface 99C1 in contact with the second cover 99B. The first cover 99A has the wall portion 99AW that covers the second locking portion 99Cb in the second direction. The wall portion 99AW is arranged in the second direction with respect to the second cover 99B. The second direction intersects with the first direction.

According to such a constitution, the wall portion covers the second locking portion. When an external force is applied from a direction intersecting the first direction, the seal portion protruding toward the outside of the second cover 99B through the opening 99Aop and the opening 99Bop is less likely to move in the acting direction of the external force. Therefore, displacement of the seal portion locked to the second cover 99B is suppressed. As described above, in the present embodiment, it is easy to suppress unintentional detachment of the packing. The wall portion 99AW protects the second locking portion 99Cb from the pressure of high-pressure cleaning, for example.

Note that the packing may not have a rod shape. For example, the main portion of the packing may be formed in an annular shape, and the main portion may be provided with a rod-shaped seal portion extending in the first direction. In this case, the rod-shaped seal portion may not be provided with respect to the main portion. That is, a protruding seal portion may be provided in the main portion instead of the rod-shaped seal portion. It is sufficient that the packing protrudes to the outside of the second cover 99B through the first opening 99Aop and the second opening 99Bop.

In addition, according to the present embodiment, the seal portion protruding to the outside of the second cover through the opening 99Aop and the opening 99Bop is less likely to move in the acting direction of the external force, so that axial displacement of the seal portion attached to the base portion 20k is less likely to occur. Since the axial displacement of the seal portion is less likely to occur, the connector 200 in the present embodiment easily ensures the waterproof performance. In addition, tearing of the seal portion due to the axial displacement of the seal portion is also suppressed.

In addition, according to the present embodiment, the base portion 20k protrudes toward the first opening (opening 99Aop). With this constitution, water is less likely to accumulate at the attachment portion of the seal portion.

In addition, according to the present embodiment, either the hole or the recess has a first inclined surface (inclined surface 20W4) inclined so as to expand toward the first opening. The seal portion has a second inclined surface (second surface 99C2) that has a diameter gradually increasing from the first locking portion 99Ca to the flange portion 99Cc. With this constitution, when an external force is applied in the first direction, the seal portion is less likely to move in the acting direction of the external force. Therefore, in the present embodiment, it is easy to suppress unintentional detachment of the packing.

In addition, according to the present embodiment, the connector housing 21, the seal portion, the first cover 99A, and the second cover 99B are arranged in this order toward the outside of the connector housing 21. With this constitution, the second cover 99B covers the first cover 99A from the side opposite to the fitting portion 20a. Therefore, the waterproof property of the connector housing 21 on the second cover 99B side is easily improved.

In addition, according to the present embodiment, the fixing member 99D that fixes the first cover 99A and the second cover 99B in the first direction is further provided. The first cover 99A has the fixing portion 99Da to which the fixing member 99D is fixed in the first direction. The second cover 99B has an insertion hole through which the fixing member 99D can be inserted. The wall portion 99AW is located on the rotation locus of the second cover 99B around the axis of the insertion hole. With this constitution, the seal portion is less likely to move around the axis of the insertion hole of the second cover 99B. Therefore, the axial displacement of the seal portion attached to the base portion 20k is less likely to occur. Since the axial displacement of the seal portion is less likely to occur, the connector 200 in the present embodiment easily ensures the waterproof performance. In addition, tearing of the seal portion due to the axial displacement of the seal portion is also suppressed.

In addition, according to the present embodiment, the fixing member 99D covers the second locking portion 99Cb in the second direction (for example, in the X direction or the Y direction). With this constitution, the fixing member 99D is used instead of the wall portion 99AW. Therefore, the wall portion 99AW may not be provided on the first cover 99A. The shape of the first cover 99A is simplified.

In addition, according to the present embodiment, the fixing member is a screw or a bolt. Since the first cover 99A and the second cover 99B are fixed by the fixing member 99D, a gap between the opening 99Aop and the opening 99Bop is more easily filled. Therefore, the connector 200 in the present embodiment more easily ensures the waterproof performance.

In addition, according to the present embodiment, the wire harness 300 includes the connector 200 and the terminal-attached electric wire 100 assembled to the connector housing 21. With this constitution, the wire harness 300 can more easily ensure the waterproof performance.

In addition, according to the present embodiment, the terminal-attached electric wire 100 includes the electric wire 101 and the terminal portion 102. The terminal portion 102 is accommodated in the connector housing 21. The electric wire 101 is drawn out in the first direction. With this constitution, the waterproof property of the wire harness 300 on the fitting portion 20a side is easily improved.

### (First Modification Example)

In the present modification example, the core wire 101A may be a single wire. Alternatively, the core wire 101A may include a plurality of sub-strands, each of which is made by twisting a plurality of wire filaments. When the core wire 101A includes the plurality of sub-strands, the core wire 101A is easily bent. Accordingly, the terminal portion 102 and the electric wire 101 are easily disposed in the first direction. With this constitution, the waterproof property of the wire harness 300 on the fitting portion 20a side is easily improved.

As described above, the embodiment and the modification example have been described. However, the embodiment and the modification examples are not limited to the examples described above. For example, the embodiment and the modification example may be implemented in combination with each other.

### INDUSTRIAL APPLICABILITY

According to one embodiment, it is easy to suppress unintentional detachment of the packing.

### REFERENCE SIGNS LIST

300 Wire harness
100 Terminal-attached electric wire
101 Electric wire
101A Core wire
101B Covering portion
102 Terminal portion
102A Terminal connection portion
102B Wire connection portion
102L Terminal portion
102R Terminal portion
200 Connector
21 Connector housing
20a Fitting portion
20b Flange portion
20c Lead-out port
20d First accommodating portion
20e Second accommodating portion
20f Locking portion
20g Fixing portion
20k Base portion
20U Front holder
20V Housing body
20W Cover member
20W1 First surface
20W2 Second surface
20W3 Stepped surface
20W4 Inclined surface
22 Terminal holding member
221 Cylindrical portion
222 Locked portion
23 Seal member
24 Seal member
25 Seal member
26 Wire holding tool
27 Shield shell
271 Cylindrical portion
272 Flange portion
272c Through hole
28 Braided member
29 Seal ring
71 Fastening member
72 Fastening member
99A First cover
99Ag Fixing portion
99Agg Fixing portion
99Aop First opening
99AW Wall portion
99Da Fixing portion
99B Second cover
99Bop Second opening
99C Seal member
99C1 First surface
99C2 Second surface
99Ca First locking portion
99Cb Second locking portion
99Cc Flange portion
99D Fixing member
510 Terminal fitting
511 Terminal connection portion

What is claimed is:

1. A connector comprising:
a connector housing that has a fitting portion capable of being fitted to a mating connector in a first direction;
a first cover that has a first opening and covers the connector housing from a side opposite to the fitting portion in the first direction;
a second cover that has a second opening and covers the first opening; and
a seal portion that extends in the first direction, is an elastic body, and includes a first locking portion, a second locking portion, and a flange portion,
wherein the connector housing includes a base portion having either a hole or a recess in the first direction,
wherein the first locking portion is attached to the base portion at either the hole or the recess,
wherein the second locking portion protrudes to outside of the second cover through the first opening and the second opening in the first direction,
wherein the flange portion has a first surface in contact with the second cover,
wherein the first cover has a wall portion that covers the second locking portion in a second direction,
wherein the wall portion is arranged in the second direction with respect to the second cover, and
wherein the second direction intersects with the first direction.

2. The connector according to claim 1, wherein the base portion protrudes toward the first opening.

3. The connector according to claim 1,
wherein either the hole or the recess has a first inclined surface inclined so as to expand toward the first opening, and
wherein the seal portion has a second inclined surface that has a diameter gradually increasing from the first locking portion to the flange portion.

4. The connector according to claim 3,
wherein, toward outside of the connector housing,
the connector housing, the seal portion, the first cover, and the second cover are arranged in this order.

5. The connector according to claim 3, further comprising:
a fixing member that fixes the first cover and the second cover in the first direction,
wherein the first cover has a fixing portion to which the fixing member is fixed in the first direction,
wherein the second cover has an insertion hole through which the fixing member is capable of being inserted, and
wherein the wall portion is located on a rotation locus of the second cover around an axis of the insertion hole.

6. The connector according to claim 5, wherein the fixing member covers the second locking portion in the second direction.

7. The connector according to claim 5, wherein the fixing member is a screw or a bolt.

8. A wire harness comprising:
the connector according to claim 1; and
a terminal-attached electric wire that is assembled to the connector housing.

9. The wire harness according to claim 8,
wherein the terminal-attached electric wire includes an electric wire and a terminal portion,
wherein the terminal portion is accommodated in the connector housing, and
wherein the electric wire is drawn out in the first direction.
